(19) United States
(12) Patent Application Publication
(10) Pub. No.: US 2023/0118473 A1
(43) Pub. Date: Apr. 20, 2023

(54) CUSTOMIZABLE ELECTRIC VEHICLE

(71) Applicant: FLIPKART INTERNET PRIVATE LIMITED, Bengaluru (IN)

(72) Inventor: Ravi Shamrao, Thane (IN)

(73) Assignee: FLIPKART INTERNET PRIVATE LIMITED, Bengaluru (IN)

(21) Appl. No.: 17/716,420

(22) Filed: Apr. 8, 2022

(30) Foreign Application Priority Data
Oct. 20, 2021 (IN) 202141047697

(51) Int. Cl. B60P 1/64; B60L 58/10; B60R 16/033; B62D 63/02

(52) U.S. Cl. CPC B60P 1/6409; B60L 58/10; B60P 1/6418; B60R 16/033; B62D 63/025

(57) ABSTRACT

A customizable electric vehicle and a method of transporting a variable load by the customizable electric vehicle. The customizable electric vehicle comprises a pilot cabin, and one or more customizable payload compartments. At least one customizable payload compartment of the one or more customizable payload compartments comprises: a battery system, configured to provide a power to run one or more units of the at least one customizable payload compartment; a motor system, configured to provide a mobility power to the at least one customizable payload compartment; a braking system, configured to provide a motion controlling power to the at least one customizable payload compartment; and a power management system, configured to manage at least one of the battery system, the motor system and the braking system of the at least one customizable payload compartment.

### TECHNICAL FIELD

The field generally relates to electric mobility and more particularly to a customizable electric vehicle and a method of transporting a variable load by the customizable electric vehicle.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In the automobile sector, a number of technologies have been developed over a period of time to produce environment-friendly vehicles. An electric vehicle is such a vehicle that is not only environment-friendly but also provides a number of benefits over existing fuel vehicles. For instance, electric vehicles are low maintenance vehicles where fuel vehicles need to add up the fluid transmission, coolant, and engine oil; there are no such requirements in electric vehicles. Also, electric vehicles are non-polluting and reliable in terms of performance.

Although electric vehicles have a number of advantages and technical advancements over fuel vehicles, there are a number of limitations of such electric vehicles. In order to overcome some of the limitations of the electric vehicles, a number of solutions are developed over a period of time. Some of the existing technologies provide a solution to optimize an operation of a power source of an electric vehicle, where the power source is comprised of a first battery pack (e.g., a non-metal-air battery pack) and a second battery pack (e.g., a metal-air battery pack). In said solutions the power source is optimized to minimize use of the least efficient battery pack (e.g., the second battery pack) while ensuring that the electric vehicle has sufficient power to traverse an expected travel distance before a next battery charging cycle. Also, some other known technologies provide a rechargeable split battery system, where a battery system is split into first and second battery subsystems. When the first battery subsystem reaches a first discharge level, the first battery system is decoupled from output terminals of the battery system and the second battery subsystem is coupled to the output terminals of the battery system. Therefore, in an event, using said solution an electric vehicle can switch a battery to provide sufficient reserve power to get the electric vehicle safely back to a recharging station without stranding the vehicle operator. The currently known solutions are therefore focused on enhancing the battery systems of the electric vehicles and fail to provide a customized electric vehicle that can transport a variable load.

More particularly, the existing electric vehicles have a fixed configuration of weight, volume and distance range that can be covered before a next battery charging cycle. This means the current electric vehicle models are tailor-made for particular customer needs. Furthermore, from a fleet operator’s point-of-view, electric vehicle purchase decisions are tradeoffs between the needs of their customer, customer contracts, the cost of the electric vehicles and return on investment (ROI). Also, from the customer point-of-view, there are tradeoffs between the uncertainties of actual load and the fleet owners’ utilizations etc. Currently, there are no solutions that can overcome these above stated limitations. Therefore, there remains a need to provide a customized electric vehicle that can transport a variable load, in order to at least find a solution for these tradeoffs and achieve an optimum and deterministic value creation for each of these stakeholders.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a customized electric vehicle that can transport a variable load. Another object of the present invention is to introduce flexibility & modularity in electric vehicle configurations. Also, an object of the present invention is to provide an arrangement with independent mobility power for different sections of the electric vehicle namely a pilot cabin and a payload compartment. Another object of the present invention is to entail a complete independent set of systems for both the pilot cabin and the payload compartment which includes at least a battery system, motor system, braking system and power management system. Also, an object of the present invention is to provide an arrangement of a motor and a battery system designed specifically for a pilot cabin configuration (i.e., that can curb weight with a single seat, two seat and like arrangements). Another object of the present invention is to provide an arrangement of a motor and a battery system that is designed specifically for a payload compartment configuration (Weight, Volume and Distance Range). Another object of the present invention is to provide an arrangement where a battery system of the payload compartment can be augmented with additional battery packs to achieve extended trip parameters. Also, an object of the present invention is to enable the electric vehicles’ fleet owner to take up a logistic assignment without restrictions of load configurations of the electric vehicles like weight, volume and a distance range to be covered. An object of the present invention is to provide an arrangement in the electric vehicles where the pilot cabin will always be in a master mode and the payload compartment will always be in a slave configuration that can be controlled by the pilot cabin controls. Another object of the present invention is to provide a capability to the pilot cabin of the electric vehicles to host a central power management for both the pilot cabin and the payload compartment of the electric vehicles. Yet another object of the present invention is to provide an inter coupling of a fixed pilot cabin with a wide range of payload compartment configurations.

Furthermore, in order to achieve the aforementioned objectives, the present invention provides a customizable electric vehicle and a method of transporting a variable load by the customizable electric vehicle.

A first aspect of the present invention relates to a customizable electric vehicle. The customizable electric vehicle comprises a pilot cabin, and one or more customizable payload compartments. At least one customizable payload compartment of the one or more customizable payload compartments comprises: a battery system, configured to provide a power to run one or more units of the at least one customizable payload compartment; a motor system, configured to provide a mobility power to the at least one customizable payload compartment; a braking system, configured to provide a motion controlling power to the at least one customizable payload compartment; and a power management system, configured to manage at least one of the battery system, the motor system and the braking system of the at least one customizable payload compartment.

Another aspect of the present invention relates to a method of transporting a variable load by a customizable electric vehicle. The method encompasses providing in the customizable electric vehicle, one or more customizable payload compartments detachably connected to a pilot cabin, to transport the variable load. At least one customizable payload compartment of the one or more customizable payload compartments comprises: a battery system, configured to provide a power to run one or more units of the at least one customizable payload compartment; a motor system, configured to provide a mobility power to the at least one customizable payload compartment; a braking system, configured to provide a motion controlling power to the at least one customizable payload compartment; and a power management system, configured to manage at least one of the battery system, the motor system and the braking system of the at least one customizable payload compartment.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary customizable electric vehicle (in connected [100 B] and disconnected state [100 A]), in accordance with exemplary embodiments of the present invention.

FIG. 1A illustrates an exemplary customizable electric vehicle with two customizable payload compartments, in accordance with exemplary embodiments of the present invention.

FIG. 2 illustrates exemplary units/systems in an exemplary customizable electric vehicle, in accordance with exemplary embodiments of the present invention.

FIG. 3 illustrates an exemplary use case of an exemplary customizable electric vehicle, in accordance with exemplary embodiments of the present invention.

FIG. 4 illustrates an exemplary method [400] of transporting a variable load by an exemplary customizable electric vehicle, in accordance with exemplary embodiments of the present invention.

The foregoing shall be more apparent from the following more detailed description of the disclosure.

### DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

As disclosed in the background section, existing technologies have many limitations and in order to overcome at least some of the limitations of the prior known solutions, the present disclosure provides a customizable electric vehicle and a method of transporting a variable load by the customizable electric vehicle. More particularly, the customizable electric vehicle as disclosed in the present disclosure encompasses a pilot cabin and one or more customizable payload compartments. The customizable payload compartment(s) of the customizable electric vehicle are detachably connected to the pilot cabin of the customizable electric vehicle. Also, each of the pilot cabin and the customizable payload compartments have their independent systems such as including but not limited to a battery and a motor system which introduce flexibility & modularity in the customizable electric vehicle configurations. Furthermore, the pilot cabin of the customizable electric vehicle also have a power management system that hosts a central power management unit of each of the pilot cabin and the one or more customizable payload compartment of the customizable electric vehicle. More specifically, the pilot cabin and the one or more customizable payload compartments of the customizable electric vehicle are connected in a master-slave configuration, where the pilot cabin is configured in the master mode and each customizable payload compartment is configured in the slave mode. Therefore, the one or more customizable payload compartments may have one or more self-sufficient systems such as including but not limited to the motor and the battery systems that are controlled through the pilot cabin. Also, in an implementation, the battery system of the one or more customizable payload compartments may be augmented with one or more additional battery packs to achieve extended trip parameters. The customizable electric vehicle as disclosed in the present invention, due to its unique configuration, enables an electric vehicle (eV) fleet owner to take up a logistic assignment without restrictions of load configurations of the eV vehicle like weight, volume & distance range.

Therefore, the present invention provides a novel solution of providing a customizable electric vehicle and a method of transporting a variable load by the customizable electric vehicle. The arrangement of various systems (such as motor, battery, power management & braking system etc.) within the customizable electric vehicle makes it modular and configurable by splitting said customizable electric vehicle into a Pilot cabin and Payload compartments with each having its own set of systems (such as motor, battery, power management & braking system etc.). Therefore, based on the implementation of the features of the present invention, an opportunity is provided to provide independent set of systems to Pilot cabin and Payload compartments in order to further overcome the limitations of the currently known solutions. The present invention also provides a method to control the independent set of systems of the Pilot cabin and Payload compartments and opens up various opportunities of having endless configurations between the Pilot cabin and the Payload compartments to suit precious requirements of a mobility assignment. Also, the present invention brings modularity to fleet owners as well as customers’ dynamics in load allocation, which is very prominent in an e-commerce supply chain. The present invention can be applied to bring in flexibility to any range of load and range requirements.

Hereinafter, exemplary embodiments of the present disclosure will be described in detail with reference to the accompanying drawings so that those skilled in the art can easily carry out the present disclosure.

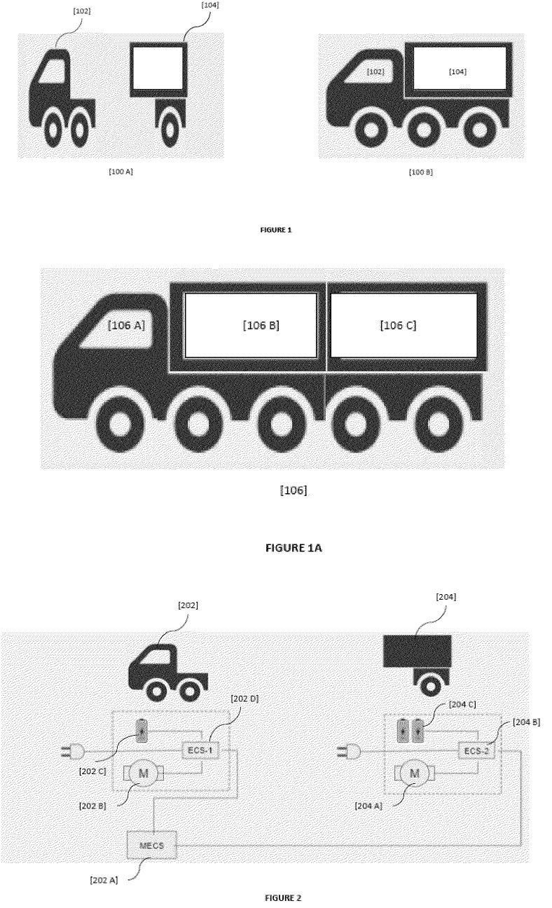

Referring to FIG. 1, an exemplary customizable electric vehicle (in connected state [100 B] and disconnected state [100 A]) is shown, in accordance with exemplary embodiments of the present invention. The customizable electric vehicle comprises a pilot cabin [102] and one or more customizable payload compartments [104]. In the customizable electric vehicle the one or more customizable payload compartments [104] are detachably connected to the pilot cabin [102]. Therefore, the one or more customizable payload compartments [104] can be easily detached from the pilot cabin [102]. Furthermore, FIG. 1 at [100 A] depicts a pilot cabin [102] and a customizable payload compartment [104] in a detached state and FIG. 1 at [100 B] depicts the pilot cabin [102] and the customizable payload compartment [104] in a connected state. In an implementation the one or more customizable payload compartments [104] are connected with the pilot cabin [102], via a standardized mechanical coupling. Also, in an event where in a customizable electric vehicle more than one customizable payload compartments [104] are present, said customizable electric vehicle may be configured in a structure similar to a train. For instance, FIG. 1A at [106] depicts an exemplary customizable electric vehicle with two customizable payload compartments, in accordance with exemplary embodiments of the present invention. More specifically, FIG. 1A at [106 B] and [106 C] depicts two customizable payload compartments that are connected with a payload cabin [106 A], wherein a train like structure of the exemplary customizable electric vehicle is formed based on the coupling between the payload cabin [106 A] and the two customizable payload compartments [106 B] and [106 C].

Furthermore, the pilot cabin [102] of the customizable electric vehicle comprises a set of systems such as at least one battery system, at least one motor system, at least one braking system and at least one power management system. The battery system of the pilot cabin [102] is configured to provide a power to run one or more units/systems of the pilot cabin [102]. For instance, the battery system of the pilot cabin [102] may be configured to provide a power required to perform one or more respective operations of at least one of the motor system of the pilot cabin [102], the braking system of the pilot cabin [102] and the power management system of the pilot cabin [102]. Also, the motor system of the pilot cabin [102] is configured to provide a mobility power to the pilot cabin [102]. Further, the braking system of the pilot cabin [102] is configured to provide a motion controlling power to the pilot cabin [102]. Also, the power management system of the pilot cabin [102] is configured to manage at least one of the battery system, the motor system and the braking system of the pilot cabin [102]. The power management system of the pilot cabin [102] further comprises at least one charging plug-in point to charge the battery system of the pilot cabin [102].

In an implementation, the battery system of the pilot cabin [102] may comprise a constant battery power pack, wherein a capacity of said constant battery power pack is sufficient to carry one or more people (such as a driver) and run a pre-defined distance range of X kms at Y speed, irrespective of weight of the one or more customizable payload compartments [104]. Therefore, in the given implementation, dimensions and battery capacity of the pilot cabin [102] may be constant and unchanged.

Also, at least one customizable payload compartment of the one or more customizable payload compartments [104] comprises a set of systems such as at least one battery system, at least one motor system, at least one braking system and at least one power management system. The battery system of the at least one customizable payload compartment is configured to provide a power to run one or more units/systems of the at least one customizable payload compartment. For instance, the battery system of the at least one customizable payload compartment may be configured to provide a power required to perform one or more respective operations of at least one of the motor system of the at least one customizable payload compartment, the braking system of the at least one customizable payload compartment and the power management system of the at least one customizable payload compartment. Also, in an implementation, the battery system of the at least one customizable payload compartment of the one or more customizable payload compartments [104] further comprises an arrangement for one or more additional batteries. Therefore, in the given implementation extended trip parameters may be achieved. Further, the motor system of the at least one customizable payload compartment is configured to provide a mobility power to the at least one customizable payload compartment. The braking system of the at least one customizable payload compartment is configured to provide a motion controlling power to the at least one customizable payload compartment. The power management system of the at least one customizable payload compartment is configured to manage at least one of the battery system, the motor system and the braking system of the at least one customizable payload compartment. Also, the power management system of the at least one customizable payload compartment further comprises at least one charging plug-in point to charge the battery system of the at least one customizable payload compartment.

In an implementation each customizable payload compartment of the one or more customizable payload compartments [104] consists of a fixed capacity of volume and weight for carrying a load. Also, in the given implementation, the battery system of the at least one customizable payload compartment of the one or more customizable payload compartments [104] may comprise a fixed battery pack to run the at least one customizable payload compartment at a pre-defined range of distance and speed, irrespective of the weight of the pilot cabin [102]. Also, in the given implementation, the fixed battery pack (i.e. the battery capacity) is proportional to the capacity of said at least one customizable payload compartment. Therefore, in the given implementation at least the motor and battery system of the at least one customizable payload compartment is tailor made depending on the configuration (i.e., the volume and weight) of the at least one customizable payload compartment.

Therefore, each of the pilot cabin [102] and the at least one customizable payload compartment of the one or more customizable payload compartments [104] comprises corresponding independent set of systems that overcomes the limitations of the prior known solutions at least by introducing flexibility & modularity in the electric vehicle configurations. More particularly, the arrangement of: the splitting/detaching the one or more customizable payload compartments [104] and the pilot cabin [102], and the independent set of systems of the payload compartment(s) [104] and the pilot cabin [102], provides a technical advancement of attaching with the pilot cabin [102] the one or more customizable payload compartments [104] of any capacity. Therefore, based on the implementation of the features of the present invention, during an operation, in a customizable electric vehicle, payload compartment(s) of any capacity may be attached to a pilot cabin without worrying about speed, volume and Kms implications.

Furthermore, in the customizable electric vehicle as disclosed in the present invention, the pilot cabin [102] and the one or more customizable payload compartments [104] are configured in a master-slave configuration, wherein the pilot cabin [102] is configured in a master mode to run each of the one or more customizable payload compartments [104] and each customizable payload compartment of the one or more customizable payload compartments [104] is configured in a slave mode. Therefore, each customizable payload compartment of the one or more customizable payload compartments [104] is controlled by the pilot cabin [102]. Also, in an implementation, the power management system of the pilot cabin [102] is configured to host a central power management unit of each of the pilot cabin [102] and the at least one customizable payload compartment of the one or more customizable payload compartments [104]. In an implementation to host the central power management unit of each of the pilot cabin [102] and the at least one customizable payload compartment, the power management system of the pilot cabin [102] is configured to continuously monitor, one or more batteries of the battery system of the at least one customizable payload compartment. Thereafter in the given implementation, the power management system of the pilot cabin [102] is configured to automatically balance a power, by one of drawing a required power from the battery system of the pilot cabin [102] and lending the required power to the battery system of the pilot cabin [102], based on said continuous monitoring. For instance, FIG. 2 depicts exemplary units/systems in an exemplary customizable electric vehicle, in accordance with exemplary embodiments of the present invention. More specifically, in FIG. 2 at [202 D] and [204 B], a power management system (i.e., electronic control system (ECS)) of a pilot cabin [202] and a customizable payload compartment [204] is depicted, respectively. The ECS shown at [202 D] manages at least an independent battery system [202 C] of the pilot cabin [202] and an independent motor system [202 B] of the pilot cabin [202]. The ECS shown at [204 B] manages at least an independent battery system [204 C] of the payload compartment [204] and an independent motor system [204 A] of the payload compartment [204]. Also, the ECS shown at [202 D] may include a master electronic control system (MECS) [202 A] of the pilot cabin [202]. In an implementation the MECS [202 A] of the pilot cabin [202] is configured to manage both the ECS depicted at [202 D] and [204 B]. For instance, in an event the master electronic control system (i.e. MCES [202 A]) is configured to: continuously monitor one or more batteries of the battery system of at least the payload compartment [204], and balance a power based on said continuous monitoring, wherein the power may be balanced either by drawing a required power from the battery system of the pilot cabin [202] or by lending the required power to the battery system of the pilot cabin [202] on a need basis. Furthermore, the master electronic control system [202 A] is configured to automatically balance the power based on a configuration setup in it. The requirement of 2-way power balancing between the pilot cabin [202] and the customizable payload compartment [204] may be based on conditions such as including but not limited to route conditions like road irregularities and life of batteries etc. Therefore, the present invention provides a technical advancement over the currently known solutions by balancing a power between the pilot cabin [202] and the customizable payload compartment [204].

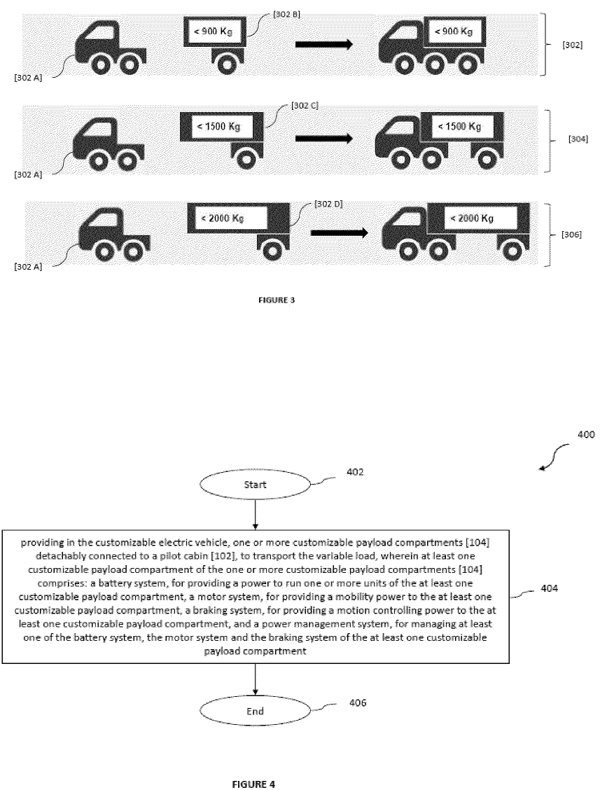

Also, in an implementation, the pilot cabin [102] is a fixed pilot cabin and each customizable payload compartment of the one or more customizable payload compartments [104] is a detachable customizable payload compartment. The fixed pilot cabin indicates that the dimensions and battery capacity of the pilot cabin [102] is fixed/constant. Further, as the dimensions and battery capacity of the pilot cabin [102] is fixed and each customizable payload compartment of the one or more customizable payload compartments [104] is the detachable customizable payload compartment, any customizable payload compartment of any capacity may be attached with the pilot cabin [102] in accordance with the implementation of the features of the present invention. Furthermore, referring to FIG. 3, an exemplary use case of an exemplary customizable electric vehicle is shown, in accordance with exemplary embodiments of the present invention. More particularly, FIG. 3 depicts 3 exemplary scenarios ([302]-[306]), where a pilot cabin [302 A] is fixed and three customizable payload compartments of varying configurations ([302 B]—[302 D]) may be connected to the fixed pilot cabin. As indicated in FIG. 3 the fixed pilot cabin [302 A] may be connected with the customizable payload compartment of: weight < 900 Kg, weight < 1500 Kg and weight < 2000 Kg based on the implementation of the features of the present invention.

Referring to FIG. 4, an exemplary method [400] of transporting a variable load by an exemplary customizable electric vehicle is shown, in accordance with exemplary embodiments of the present invention. Also, as shown in FIG. 4, the method starts at step [402].

Further, at step [404] the method comprises providing in the customizable electric vehicle, one or more customizable payload compartments [104] and a pilot cabin [102]. The one or more customizable payload compartments [104] are detachably connected to the pilot cabin [102], to transport the variable load. Also, at least one customizable payload compartment of the one or more customizable payload compartments [104] comprises a set of systems such as at least one battery system, at least one motor system, at least one braking system and at least one power management system.

The battery system of the at least one customizable payload compartment provides a power to run one or more units/systems of the at least one customizable payload compartment. Also, in an implementation, the battery system of the at least one customizable payload compartment of the one or more customizable payload compartments [104] further comprises an arrangement for one or more additional batteries. The motor system of the at least one customizable payload compartment provides a mobility power to the at least one customizable payload compartment. The braking system of the at least one customizable payload compartment provides a motion controlling power to the at least one customizable payload compartment. The power management system of the at least one customizable payload compartment manages at least one of the battery system, the motor system and the braking system of the at least one customizable payload compartment. The power management system of the at least one customizable payload compartment further comprises at least one charging plug-in point to charge the battery system of the at least one customizable payload compartment.

Also, the pilot cabin [102] of the customizable electric vehicle comprises a set of systems such as at least one battery system, at least one motor system, at least one braking system and at least one power management system. The battery system of the pilot cabin [102] provides a power to run one or more units/systems of the pilot cabin [102]. For instance, the battery system of the pilot cabin [102] may provide a power required to perform one or more respective operations of at least one of the motor system of the pilot cabin [102], the braking system of the pilot cabin [102] and the power management system of the pilot cabin [102]. Also, the motor system of the pilot cabin [102] provides a mobility power to the pilot cabin [102]. Further, the braking system of the pilot cabin [102] provides a motion controlling power to the pilot cabin [102]. Also, the power management system of the pilot cabin [102] manages at least one of the battery system, the motor system and the braking system of the pilot cabin [102]. The power management system of the pilot cabin [102] further comprises at least one charging plug-in point to charge the battery system of the pilot cabin [102].

Furthermore, in the customizable electric vehicle as disclosed in the present invention, the pilot cabin [102] and the one or more customizable payload compartments [104] are configured in a master-slave configuration, wherein the pilot cabin [102] is configured in a master mode to run each of the one or more customizable payload compartments [104] and each customizable payload compartment of the one or more customizable payload compartments [104] is configured in a slave mode. Therefore, each customizable payload compartment of the one or more customizable payload compartments [104] is controlled by the pilot cabin [102]. For instance, in an event, the method encompasses continuously monitoring by the power management system of the pilot cabin [102], one or more batteries of the battery system of at least the payload compartment [104]. The method thereafter encompasses automatically balancing by the power management system of the pilot cabin [102], a power based on said continuous monitoring, wherein the power may be balanced either by drawing a required power from the battery system of the pilot cabin [102] or by lending the required power to the battery system of the pilot cabin [102] on a need basis. Furthermore, the power management system of the pilot cabin [102] automatically balances the power based on a configuration setup in it. The requirement of 2-way power balancing between the pilot cabin [102] and the customizable payload compartment [104] may be based on conditions such as including but not limited to route conditions like road irregularities and life of batteries etc. The present invention thus provides a technical advancement over the currently known solutions by balancing a power between the pilot cabin [102] and the customizable payload compartment [104].

Also, as each of the pilot cabin [102] and the at least one customizable payload compartment of the one or more customizable payload compartments [104] comprises corresponding independent set of systems, the present invention overcomes the limitations of the prior known solutions at least by introducing flexibility & modularity in the electric vehicle configurations. More particularly, the arrangement of: the splitting/detaching the one or more customizable payload compartments [104] and the pilot cabin [102], and the independent set of systems of the payload compartment(s) [104] and the pilot cabin [102], provides a technical advancement of attaching with the pilot cabin [102] the one or more customizable payload compartments [104] of any capacity for transporting the variable load. Therefore, for transporting the variable load, based on the implementation of the features of the present invention, during an operation, in a customizable electric vehicle, payload compartment(s) of any capacity may be attached to a pilot cabin without worrying about speed, volume and Kms implications.

Further, based on the implementation of the features of the present invention, once the variable load is transmitted by the customizable electric vehicle, the method thereafter terminates at step [406].

Thus, the present invention provides a novel solution of providing a customizable electric vehicle and a method of transporting a variable load by the customizable electric vehicle. The arrangement of various systems (such as motor, battery, power management & braking system etc.) within the customizable electric vehicle makes it modular and configurable by splitting said customizable electric vehicle into a Pilot cabin and Payload compartments with each having its own set of systems (such as motor, battery, power management & braking system etc.). Therefore, based on the implementation of the features of the present invention, an opportunity is provided to provide independent set of systems to Pilot cabin and Payload compartments in order to further overcome the limitations of the currently known solutions. The present invention also provides a method to control the independent set of systems of the Pilot cabin and Payload compartments and opens up various opportunities of having endless configurations between the Pilot cabin and the Payload compartments to suit precious requirements of a mobility assignment. Also, the present invention brings modularity to fleet owners as well as customers’ dynamics in load allocation, which is very prominent in an e-commerce supply chain. The present invention can be applied to bring in flexibility to any range of load and range requirements.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A customizable electric vehicle comprising of:
a pilot cabin [102]; and
one or more customizable payload compartments [104], wherein at least one customizable payload compartment of the one or more customizable payload compartments [104] comprises:
a battery system, configured to provide a power to run one or more units of the at least one customizable payload compartment,
a motor system, configured to provide a mobility power to the at least one customizable payload compartment,
a braking system, configured to provide a motion controlling power to the at least one customizable payload compartment, and
a power management system, configured to manage at least one of the battery system, the motor system and the braking system of the at least one customizable payload compartment.

2. The customizable electric vehicle as claimed in claim 1, wherein the pilot cabin [102] comprises:
a battery system, configured to provide a power to run one or more units of the pilot cabin [102],
a motor system, configured to provide a mobility power to the pilot cabin [102],
a braking system, configured to provide a motion controlling power to the pilot cabin [102], and
a power management system, configured to manage at least one of the battery system, the motor system and the braking system of the pilot cabin [102].

3. The customizable electric vehicle as claimed in claim 2, wherein the power management system of the pilot cabin [102] is further configured to host a central power management unit of each of the pilot cabin [102] and the at least one customizable payload compartment.

4. The customizable electric vehicle as claimed in claim 3, wherein to host the central power management unit of each of the pilot cabin [102] and the at least one customizable payload compartment, the power management system of the pilot cabin [102] is configured to:
continuously monitor, one or more batteries of the battery system of the at least one customizable payload compartment, and
automatically balance a power, by one of drawing a required power from the battery system of the pilot cabin [102] and lending the required power to the battery system of the pilot cabin [102], based on said continuous monitoring.

5. The customizable electric vehicle as claimed in claim 1, wherein the pilot cabin [102] and the one or more customizable payload compartments [104] are configured in a master-slave configuration, wherein the pilot cabin [102] is configured in a master mode to run each of the one or more customizable payload compartments [104] and each customizable payload compartment of the one or more customizable payload compartments [104] is configured in a slave mode.

6. The customizable electric vehicle as claimed in claim 1, wherein the battery system of the at least one customizable payload compartment of the one or more customizable payload compartments [104] further comprises an arrangement for one or more additional batteries.

7. The customizable electric vehicle as claimed in claim 1, wherein the pilot cabin [102] is a fixed pilot cabin [102] and each customizable payload compartment of the one or more customizable payload compartments [104] is a detachable customizable payload compartment.

8. A method of transporting a variable load by a customizable electric vehicle, the method comprising:
providing in the customizable electric vehicle, one or more customizable payload compartments [104] detachably connected to a pilot cabin [102], to transport the variable load, wherein at least one customizable payload compartment of the one or more customizable payload compartments [104] comprises:
a battery system, for providing a power to run one or more units of the at least one customizable payload compartment,
a motor system, for providing a mobility power to the at least one customizable payload compartment,
a braking system, for providing a motion controlling power to the at least one customizable payload compartment, and
a power management system, for managing at least one of the battery system, the motor system and the braking system of the at least one customizable payload compartment.
